(19) United States
(12) Patent Application Publication
(10) Pub. No.: US 2010/0304968 A1
(43) Pub. Date: Dec. 2, 2010

(54) PROCESS OF MANUFACTURE FOR DEER REPELLANT, PEST AND RODENT CONTROL, WEED-KILLER, FUNGICIDE AND INSECTICIDE, AND COMBINATIONS THEREOF IN POWDER AND LIQUID SPRAY FORMULATIONS

(76) Inventor: HEMANT NARAHAR JOSHI, PARSIPPANY, NJ (US)

Correspondence Address: HEMANT N. JOSHI, 41 LEAM WAY, PARSIPPANY, NJ, 07054, US

(21) Appl. No.: 12/475,493

(22) Filed: May 30, 2009

(51) Int. Cl. A01N 63/02

(52) U.S. Cl. 504/118

(57) ABSTRACT

The deer and rodent repellent, a fungicide, insecticide, a fruit spray, and a weed-killer composition can be prepared in powder delivery system. The solution of an active ingredient is distributed on an inert adsorbent matrix. The formulation can also be distributed using a suitable powder dispenser or can be filled in empty tea bags to be hung on/near the vegetation or can be mixed with a paint to be applied on the fence. A procedure to prepare a liquid formulation containing a film-forming polymer is also mentioned. Combination of actives for various applications can be put together in powder or liquid spray formulations in order to provide convenience and reduce cost to the consumer.

### BACKGROUND OF THE INVENTION

It is an American dream to have a beautiful house with an attractive landscaping. It is not easy to maintain a lawn free of weeds, maintain a flowerbed without getting damaged by deer, rabbits, groundhogs etc. We are encroaching on wild life by cutting down trees and building houses. It is common in the US to observe wild animals in the back yard. Deer can be a nuisance when they forage on the plants in our backyards or farms. People have attempted different ways to keep deer away from their properties. Due to lack of predators, the population of deer in neighborhoods is actually on the rise. Rodents such as rabbit, groundhog, raccoons etc. also attack vegetation.

One of the common ways to prevent the attack on our gardens from deer and other animals is by putting up the fence, which can turn out to be very expensive. The simplest form is a tree shelter including two semi-cylindrical cages made with biodegradable materials (US patent application 2003/208,953). Additives can be mixed in the cage material, including a bittering agent, a deer repellent or a fertilizer. Another commonly used technique is to apply chemicals on plants and gardens. The chemicals used must meet EPA's (Environmental Protection Agency) requirements and it should not be toxic to children and pet animals. Natural ingredients are preferred and U.S. Pat. No. 5,738,851 mentioned an application of extracts of plants in the Amaryllidaceae family, mainly lilies, daffodils, snow-flakes etc.

In the U.S. Pat. No. 5,985,010, the active ingredient of habanero peppers was extracted and applied directly to the object to be protected or mixed with paints, caulks, glues or rubber coatings. Habanero pepper has a distinction of being the hottest pepper known. U.S. Pat. No. 4,455,304 prepared a powder composition of garlic and cayenne pepper that was mixed with inert mineral material or water to repel birds. U.S. Pat. No. 4,795,637 described the preparation of a rodent repellent powder containing thujone oil and at least one powder selected from the group consisting of lime powder, borax powder, pyrethrum powder, silica gel, sulfur powder, sabadilla, pepper powder, and tobacco dust. It is a simple mixture of oil in a powder and the composition is devoid of misting and dusting due to the oily active ingredient. U.S. Pat. No. 6,372,240 described an aqueous formulation comprising of rosemary oil emulsion, mint oil emulsion, xanthan gum as a thickener and sufficient water. The mixture can also be soaked on a support medium such as clay or braided rope. U.S. Pat. No. 5,674,496 claimed a method of preparation of an animal repellent in which habanero capsicum with a relative hotness greater than 50,000 scoville units was extracted with at least one organic solvent. This is further mixed with paints, rubbers, caulks, plastics, glues, silicones, preservatives, vinyls, epoxies, resins, enamels and sealants. An organic deer repellent contains Capsaicin and USP grade castor oil. The formulation is stable for about 30 days. Another formulation available has peppermint oil (0.78%), Clove oil (0.54%), Cinnamon oil (0.47%), white pepper (0.069%), petrified eggs (1%) and water.

Spray formulations are widely used for a variety of applications. A marketed weed-killer formulation contains 2-Methyl-4-Chloro phenoxy acetic acid, 3,5,6 Trichloro-2-pyridinyloxy acetic acid, Dicamba, quinclorac and Mecoprop-P. A fruit tree spray contains Captan, malathion and Carbozyl. An insecticide product has pyrethrin, piperonyl butoxide and Imidacloprid. An active ingredient in a bug killer is carboryl. An insecticide/fungicide garden dust contains copper sulfate, rotenone, and cube resin as actives. All the spray compositions are bulky as they are solution or suspension formulations. A powder form of delivery system reduces the shelf-space in stores and at home, reduced cost of transportation and chemically, these are, in general, more stable formulations. Due to its dry state, the actives are more stable for a longer time.

In the powder formulation, it is difficult to distribute the active ingredients evenly mainly due to their low concentration. Also, if the active is oily, it is difficult to distribute evenly in the matrix. The invention describes the method of extraction and uniform distribution over the solid matrix. It describes a methodology to develop a formulation containing multiple of actives for many ailments. This application also describes a method to manufacture a film-forming spray formulation.

### SUMMARY OF THE INVENTION

This invention relates to a method-of-use aspect for a composition including deer and rodent repellent, insecticide, fungicide, and a weed-killer. It relates to the preparation of a delivery system to produce a powder formulation and a method of application of the same. A deer or rodent repellent composition when applied to ornamental plants and crops would deter these animals from browsing for some time.

The invention describes a method to prepare a solution of an active ingredient, which is subsequently distributed over a support matrix. Other additives such as binders, surfactants, coloring agents, and lubricants are mixed in to produce a final formulation. The powder formulation, thus made, is either spread using a powder dispenser or it is filled in sealable empty tea bags.

The primary objective of this invention is to prepare a powder delivery system for a deer/rodent repellent, insecticide, fungicide and a weed-killer. This will take away the bulkiness of such formulations. As a result, it will reduce the transportation cost and reduce the shelf space.

Another advantage of the inventions is the ability to combine various kinds of actives such as deer, rodent, insecticide repellents, weed killer, fungicide etc. so that it provides convenience and saves cost to customers.

Another advantage of the invention is the ease of use of such a delivery system.

One of the formulations in the invention relates to a deer repellent composition. The active ingredients, chili powder and garlic, are extracted using a solvent system. The solution is filtered and is spread over calcium silicate. The powder is dried in air to evaporate the solvent. An egg powder is mixed with the mixture above to produce a deer repellent composition which is then filled in a dispensing bottle.

Other novel features and scope of applicability will be described in the detailed description to follow.

In another formulation, the active ingredients, chili powder and garlic, are extracted using a solvent system. The solution is filtered and an acrylate based film-forming polymer is dissolved. The resultant solution is spread over vegetation which results in a thin and transparent film.

### DETAILED DESCRIPTION

The key components of these formulations are—a powder matrix to which the active ingredients will adsorb (highly adsorbing inert material), the active ingredients, solvent system needed to dissolve the active ingredients, a surfactant to help disperse the active over to the vegetation, an adhesive to help the powder stick to the vegetation, a colorant, a lubricant and diluents.

Powdered aluminum hydroxide, bentonite, charcoal, activated carbon, kaolin, cation exchange resin, anion exchange resin, hydrated sodium aluminum silicate (zeolite), silica, magnesium aluminum silicate, calcium aluminum silicate, clay, lime, calcium silicate and borax powder can be used as adsorbing inert materials. If the active ingredient is positively or negatively charged, it can ion-pair with the cation/anion exchange resins. The adsorption capacity of an adsorbent depends upon the properties of the adsorbent and the adsorbing substance. The key feature of the adsorbent for the purpose of this invention is its safety and efficacy apart from its adsorption capacity. The adsorbent should not have any ill effect on the vegetation where it is applied and to human subject coming in contact with the formulation.

One of the applications of this invention is to produce a deer repellent formulation. The active ingredients of a deer repellent formulation such as capsaicin, garlic extract, rosemary oil, mint oil, thujone oil, extracts of plants in the Amaryllidaceae family, peppermint oil, clove oil, cinnamon oil etc. can be dissolved in a suitable solvent system. The solution is then applied to an adsorbent matrix. The solvent was allowed to evaporate thereby producing a dry powder.

In another application of the invention, active ingredient of a weed-killer formulation (2-Methyl-4-Chloro phenoxy acetic acid (dimethyl amine salt), 3,5,6 Trichloro-2-pyridinyloxy acetic acid, Dicamba, quinclorac and Mecoprop-P), an insecticide product (pyrethrin, piperonyl butoxide and Imidacloprid), a bug killer (carboryl), a fungicide (copper sulfate and rotenone), and a fruit tree spray (Captan, malathion and Carbozyl) are dissolved in a suitable solvent system in a desired concentration. The solution is then distributed over the adsorbent material. The solvent is then allowed to evaporate to produce a dry powder.

In an another application, the active ingredients for various applications are extracted or dissolved in a suitable solvent system and loaded on a suitable powder matrix by adsorption. The dry powder is subsequently mixed with other excipients such as color, binder, glidant etc. to complete the formulation.

Commonly used organic solvents such as methanol, ethanol, isopropanol, acetonitrile, hexane, toluene, benzene, isobutyl isobutyrate, methyl ethyl ketone, methyl isobutyl ketone, aliphatic petroleum, and ether can be used to dissolve or extract the active ingredients. In some cases, aqueous solvents with a suitable pH value can be used. Based on the properties of active ingredients, one can used a mixture of solvents. In the case of organic solvents, due to their toxicological and explosive nature, special equipment may be needed and one may collect/recover the evaporated solvents.

Several additives can be added to the formulations. One set of additive could be a surfactant which would help to disperse the actives upon delivery. In some cases, the oils can be emulsified with the surfactant. If one desires to suspend the powder in water and spray, the surfactant will help wetting of the powder.

The other kind of additive could be a binder such as xanthan gum, cellulose-based polymers, acrylate-based polymers with or without a cross-linking agent. The purpose of the binder is mainly to help the powder formulation to adhere to the vegetation upon adsorption of moisture in air.

The powder formulation is filled in a powder spray bottle and sprinkled on the vegetation where needed. If a large area is needed to be covered, a suitable powder applicator device such as described in the U.S. Pat. No. 3,785,531 can be utilized.

In a formulation, one can add different shades of green color to blend in the powder formulations based on the color of the vegetation where the formulation is applied.

In one of the formulations of a deer repellent, 12 grams of chili powder and 14 grams of garlic powder were suspended in a mixture containing 60 mL water and 120 mL denatured ethanol. The mixture was shaken intermittently over two days. The suspension was filtered. The resultant solution was adsorbed onto Zeopharm 600 (calcium silicate) and allowed to air dry. Separately, one egg was mixed with 15 gram of Zeopharm 600, small amount of water and a surfactant. The mixture was cooked in a microwave with intermittent mixing. Once the egg was cooked, the powder was passed through a suitable sieve. Zeopharm loaded with chili and garlic extract was mixed with Zeopharm 600 containing egg powder and mixed well. The final composition was passed through a suitable sieve and filled in the powder spray bottles. One can add egg powder to the formulation instead of cooking the raw egg during the process.

In another example, the powdered form of deer or rodent repellent composition is filled in empty tea bags. The tea bags are hung on the plants or on the fence at several places. The bags will release the fine powder with wind or the smell of evaporated actives would repel the deer or rodents.

In another example, the powdered form of deer or rodent repellent can be mixed with the paint which can be applied to the fence. The paint will ensure a slow release of actives over a period.

In another example, the actives are either dissolved or extracted using a mixture of alcohol/water, and the solution is filtered. Additives such as film forming methacylate-based polymers (for example, Luviset Clear), are dissolved in the solution which is then sprayed over the vegetation. The polymer forms a thin film over the vegetation. The solvent selection is very critical in this case because the solvents might have detrimental effect on the vegetation.

What is claimed is:

1. A method of preparation of deer repellant, pest and rodent control, weed-killer, fungicide and insecticide, and a fruit spray powder formulations.

2. The composition of deer repellant, pest and rodent control, weed-killer, fungicide and insecticide, and a fruit spray powder formulations consisting of an active ingredient, a solid/inert adsorbent matrix, a suitable solvent system, a binder, a colorant, a surfactant, and a lubricant.

3. The method of preparation of formulations in claim 1 which consist of dissolution of active in a suitable solvent system, dispersion of the over a suitable solid adsorbent matrix, evaporation of the solvent and mixing with other additives necessary for the formulation.

4. The composition of a deer repellent formulation as in claim 2 wherein the active ingredients—egg powder, chili powder and garlic powder extract, are dispersed over calcium silicate, especially Zeopharm 600.

5. The formulation from claim 2 which is to be dispersed using a suitable powder dispenser, filled in empty tea bags to be hung on or near the vegetation, or mix it with a paint to be applied on the fence.

6. A method of preparation of deer repellant, pest and rodent control, weed-killer, fungicide and insecticide, and a fruit liquid spray formulations, which forms a film on the vegetation.

7. The method of preparation of formulation in claim 6 which consist of dissolution or extraction of actives in alcohol/water mixture, filtration and mixing of methacrylate based polymer and other ingredients.

8. The powder formulation as in claim 1 and a liquid spray formulation as in claim 6 wherein a combination of actives for various applications are used in order to provide convenience and reduce cost to consumers.
